(19) United States
(12) Patent Application Publication
(10) Pub. No.: US 2024/0305243 A1
(43) Pub. Date: Sep. 12, 2024

(54) CONTACT FOR A PHOTOVOLTAIC MODULE, AND A METHOD FOR FORMING A CONTACT

(71) Applicant: HANWHA Q CELLS GMBH, Bitterfeld-Wolfen (DE)

(72) Inventors: Ronny BAKOWSKIE, Bitterfeld-Wolfen (DE); Andreas HUBERT, Bitterfeld-Wolfen (DE); Carsten SCHULZE, Bitterfeld-Wolfen (DE)

(21) Appl. No.: 18/547,729

(22) PCT Filed: Feb. 22, 2022
(86) PCT No.: PCT/EP2022/054408

§ 371 Date: Aug. 24, 2023

(30) Foreign Application Priority Data
Feb. 25, 2021 (DE) 10 2021 104 559.2

(51) Int. Cl. H02S 40/36

(52) U.S. Cl. CPC H02S 40/36

(57) ABSTRACT

A contact for a photovoltaic module that includes a connection socket, a current collector and a soldered connection. The connection socket is attached to the photovoltaic module and includes a contacting face, the contacting face having an opening with a burr and being designed to be connected to an external supply line for the photovoltaic module. The current collector conducts an electric current from at least one solar cell in the photovoltaic module to the connection socket. The soldered connection is formed between the current collector and the contact face. The current collector extends through the opening, and the burr points away from the at least one solar cell and is accommodated at least in part by the soldered connection.

### PRIORITY CLAIM

The present application is a National Phase entry of PCT Application No. PCT/EP2022/054408, filed Feb. 22, 2022, which claims priority from German Patent Application No. 10 2021 104 559.2, filed Feb. 25, 2021, the disclosures of which are hereby incorporated by reference herein in their entirety.

### FIELD OF THE INVENTION

The present invention relates to a contact for a photovoltaic module and a method for forming a contact of a photovoltaic module and, in particular, to an improved soldering concept for electrically connecting metallizations or crosslinks in connection sockets of photovoltaic modules.

### BACKGROUND

Photovoltaic modules include a large number of solar cells that are electrically connected to a connection socket via current collectors (also called crosslinks). For this purpose, metallizations or contacting faces are provided in the connection socket, which contact the current collectors via soldered connections.

FIG. 5 shows an example of a conventional connection of metallizations 410 to current collectors 420, wherein the upper portion shows a top view of the photovoltaic module (not shown) with a connection socket 400. Below is shown a cross-sectional view. The metallizations 410 comprise openings 412 through which the current collectors 420 pass and are electrically connected to the metallization 410 via a soldered connection 430 on a side of the metallization 410 opposite to the solar cells.

In this process, the current collectors 420 are guided into the connection socket 400 and bent by at least 900 or 180° to lie flat on the metallization 410. Subsequently, a contact soldering or a contactless soldering can be carried out in order to solder the current collectors 420 to the metallization 410 (e.g., on a pre-tinned surface). In most cases, additional solder is fed externally onto the components to be soldered. The soldered connection 430 forms between the metallization 410 and the current collectors 420 (see cross-sectional view below) and is difficult to visually inspect.

This electrical connection has the disadvantage of being unreliable, particularly because visual inspection is difficult. In addition, reset forces exert a permanent force on the soldered connection 430, further compromising the reliability. As a result, conventional connection sockets have increased complaint rates. To ensure reliability, a connection is often made via a welding, clamping, screw connection or riveted connection, which offers more reliability but involves considerably more effort because automation is hardly possible.

With conventional contacts, it is possible to determine whether there is any electrical contact at all, but it often remains unclear how large the contact area/soldered connection is actually formed. For example, to minimize the risks mentioned above, the soldered connection should ideally include the entire area of the current collector 420 that is pressed/bent onto the metallization. Therefore, the solder area is typically configured over a very large area (e.g., an area of ˜ 6×6 mm²). However, this is often not achieved in conventional contact because the contact soldering process cannot be properly controlled. As a result, very small, soldered connections are created. However, these still provide an electroluminescence image, which suggests a supposedly good, soldered connection, but which in use under thermomechanical stress relatively quickly result in a failure of this soldered connection.

JP 2009-246 039 A and CN 212 012 574 U show examples of conventional connection sockets for photovoltaic modules.

The object of the present invention, therefore, is to provide an alternative contact for the current collectors with the contacting faces in the connection socket that improves the reliability of the electrical connection.

### SUMMARY OF THE INVENTION

This above-mentioned problem is solved by the contact according to claim 1 and the method according to claim 8. The dependent claims relate to advantageous further embodiments of the subject matter of the independent claims.

The present invention relates to a contact for a photovoltaic module having the following features:
a connection socket attached to the photovoltaic module and comprising a contacting face, the contacting face comprising an opening with a burr and is configured to be connected to an external supply line for the photovoltaic module;
a current collector that conducts an electric current from at least one solar cell in the photovoltaic module to the connection socket; and
a soldered connection between the current collector and the contacting face.

The current collector extends through the opening and the burr points away from the at least one solar cell and is accommodated at least in part by the soldered connection. For example, the contacting face represents a metallization. Further, the soldered connection may cover or bridge all or part of the opening, i.e., the burr on opposite sides of the opening may be directly contacted by the soldered connection.

Optionally, the burr is a punched burr, and the opening is a punched opening, wherein the opening width can be adapted to the geometry of the current collector. Optionally, the opening comprises a width (e.g., smaller than 1 mm) which is selected in such a way that the current collector is at least partially mechanically held by bending or canting at the burr.

Optionally, the current collector extends away from the solar cells almost vertically at one end and at least partially dips into the soldered connection. The end may also extend completely through the soldered connection and protrude at least partially on an opposite side.

Optionally, the contact includes a further current collector, and the connection socket includes a further contacting face and a further opening, wherein the further current collector extends through the further opening and electrically contacts the further contacting face. The contacting face and the further contacting face may be electrically connected via a bypass element (e.g., a diode).

Optionally, the current collector includes a bend down at the burr, wherein the bend forms a hook that at least makes it difficult to back out the current collector from the opening. The hooking can also improve the electrical connection, as the current collector is in direct contact with the contacting face.

Embodiments also relate to a photovoltaic module with a previously described contact.

Embodiments also relate to a method of forming a contact for a photovoltaic module, comprising the following steps:
arranging a current collector to conduct away an electric current from at least one solar cell in the photovoltaic module;
arranging of a connection socket on the photovoltaic module, wherein the connection socket comprises a contacting face having an opening and a burr and is configured to be connected to an external supply line for the photovoltaic module;
passing the current collector through the opening; and
soldering the current collector to the contacting face so that one end of the current collector and the burr are at least partially enclosed by the soldered connection.

Optionally, the method further includes bending down the current collector after passing the current collector through the opening. The bend may occur at the burr to achieve a hooking of the current collector to the burr.

The contact according to embodiments solves at least part of the problems mentioned at the beginning by a predetermined formation of a burr at the opening. Since the burr is directed away from the solar cells, the current collector, when passed through the contacting face, can be held by the burr (e.g., mechanically by hooking or canting).

Advantageously, the exemplary bypass diode can be attached to the contacting faces of the connection socket. Therefore, the contacting faces are formed, for example, of sheetlike nature in the connection socket (e.g., as rails). The openings in the contacting face may be configured by a punching or drilling operation, wherein, according to embodiments, a resulting burr is purposefully formed or not eliminated to serve as a barb. Furthermore, the burr provides additional support for the soldered connection, which extends over the burr so that the burr is at least partially immersed in or enclosed by the soldered connection. In this way, a reliable and secure electrical connection is ensured. A further advantage is that the openings according to embodiments form a funnel, which enable automatic feeding of the current collectors through the opening. This enables further automation.

With a modified guidance of the current collectors (crosslinks) and/or the geometry, the combination of current collector and contacting face can be implemented more easily and in a visually controllable manner by means of contactless soldering.

### BRIEF DESCRIPTION OF THE DRAWINGS

The embodiments of the present invention will be better understood through the following detailed description and accompanying drawings.

FIG. 1 shows a contact for a photovoltaic module according to an embodiment of the present invention.

FIG. 2 shows an exemplary photovoltaic module with a connection socket.

FIG. 3 shows a contact according to a further embodiment.

FIG. 4 shows a flow diagram for a method for contacting according to a further embodiment.

FIG. 5 illustrates conventional contact.

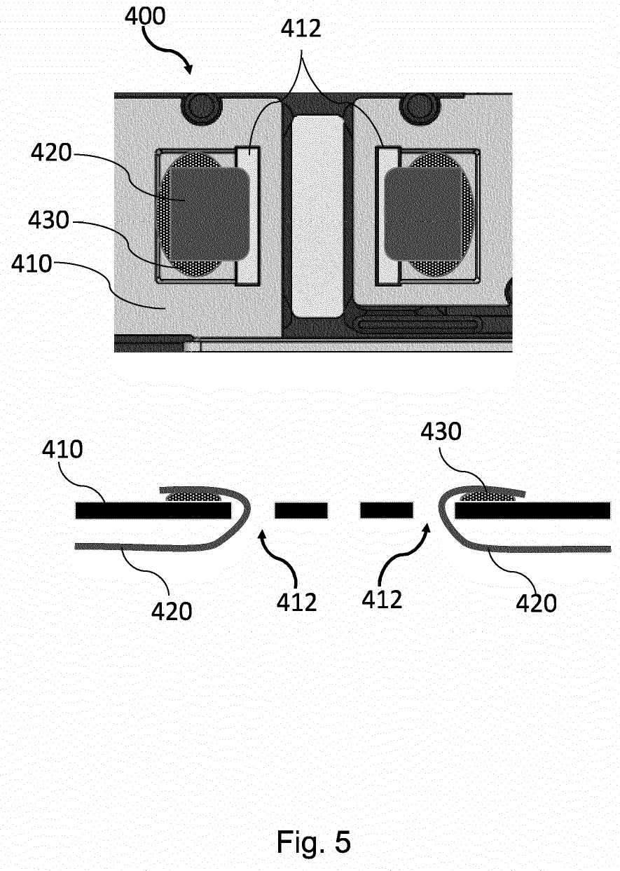

### DETAILED DESCRIPTION

In the following figures, the reference signs are chosen in such a way that all components that have the same function bear the same reference sign, i.e., contacting faces bear a common reference sign, the openings bear a common reference sign, the soldered connections bear a common reference sign, and so on.

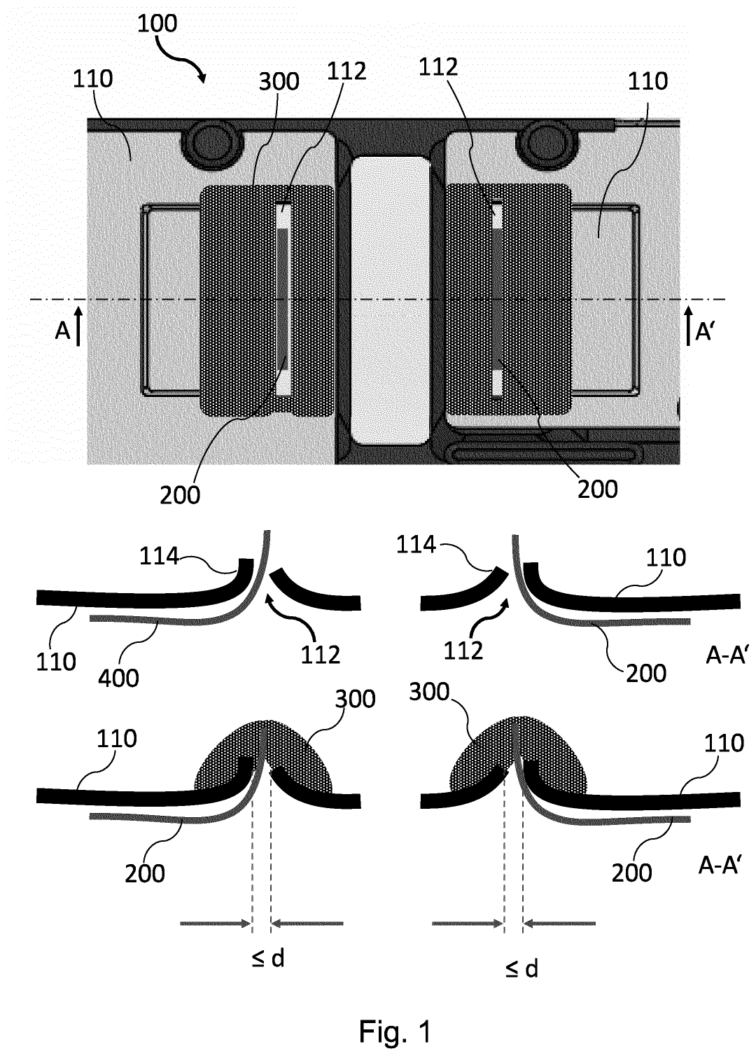

FIG. 1 shows a contact for a photovoltaic module according to an embodiment of the present invention. In FIG. 1 above, a top view of the photovoltaic module (not shown) with the connection socket 100 mounted thereon is shown. Within the connection socket 100, two exemplary contacting faces 110 are formed there, each comprising an opening 112. A current collector 200 extends through each of the openings 112 to feed current from the solar cells. The current collectors 200 are connected to the contacting faces 110 via soldered connections 300. It is understood that the number of current collectors 200, the number of openings 112 and the number of contacting faces 110 can be arbitrary. In particular, only one current collector 200 and one contact area 110 may be formed.

Two cross-sectional views are shown in the lower half of FIG. 1. The cross-sectional plane extends through the contacting faces 110 with the openings 112 along the line A-A′ (see FIG. 1 above). In the upper cross-sectional view, the soldered connections 300 are not yet formed and in the lower cross-sectional view, the soldered connections 300 are present. According to embodiments, the contacting faces 110 comprise a burr 114 pointing away from the solar cells (i.e., facing upward in the cross-sectional views) and forming an edge of the corresponding opening 112. The current collectors 200 may be formed as contact strips or rails having a rectangular cross-section. The invention is not intended to be limited to any particular shape.

The current collectors 200 extend through the openings 112 so that the burr 114 can act as a hook to aid in fixation. To enhance this effect, the width d of the openings 114 may be adjusted to match the thickness of the current collectors 200 (e.g., less than 2 mm or less than 1 mm or less than 0.5 mm). For example, the burr 114 may be at least partially immersed in or enclosed by the soldered connection 300, thereby providing improved retention. Shifting parallel to the photovoltaic module is thus prevented, as is pull-out. To further increase stability, according to further embodiments, the burr 114 may be at least partially bent back again after the current collector 200 has been passed through, in order to clamp the current collector 200 at the contacting face 110.

In addition, the burr 114 provides support for the soldered connection 300. Thermal stability is also improved as thermal stresses often result in small displacements. In contrast to the conventional connection, this enables visual inspection of the soldered connection (e.g., from above).

According to further embodiments, the opening 112 is achieved by a punched or drilled hole so that a burr is automatically formed by forming the opening 112. The burr 114 may also be created by bending up an opening slot so that ends of the severed contacting face 110 face upward (away from the solar cells) and have a similar effect as a punch burr. The opening 112 may be round or elongated in shape. However, the present invention is not intended to be limited to any particular shape of opening 112. Generally, the opening 112 is adapted to the cross-section of the current collectors 200.

The opening 112 according to embodiments further offers the advantage of forming a funnel on the side of the solar cells, which facilitates passage of the current collectors 200. In contrast to conventional contact, this enables or facilitates automation.

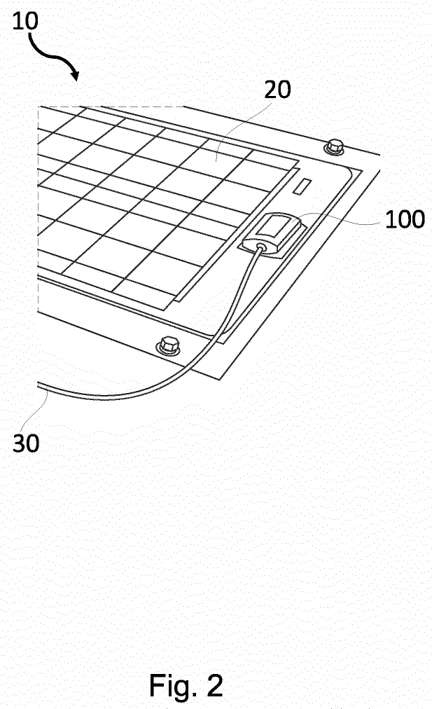

FIG. 2 shows an exemplary photovoltaic module 10 with a plurality of solar cells 20. The solar cells 20 may, for example, be connected in series (in so-called strings), which in turn are arranged in parallel along the photovoltaic module 10. The current generated by the solar cells 20 is collected by the current collectors 200 (not shown in FIG. 2), and together they are forwarded to the connection sockets 100. The connection socket 100 may be arranged, for example, on a rear side, i.e., a side facing away from the light irradiation, of the photovoltaic module 10 and is connected to external supply lines 30. The supply lines 30 conduct current away from the photovoltaic module 10. The current collectors 200 are therefore at least part of the connection lines from the connection socket to the individual serially connected solar cells and conduct the electric current to the connection socket 100.

According to further embodiments, the connection socket 100 need to have only one current collector 200 and only one contacting face 110. If, as shown, two current collectors 200 and two contacting faces (pads) 110 are formed, the contact faces 110 may be utilized to connect a bypass diode or another bypass element therewith as a bypass between the two contacting faces 110. The bypass diode may also be electrically contacted by the configured soldered connections 300. The exemplary at least one diode has the effect of bypassing at least a portion of the solar module if there is a risk of overloading some solar cells in the solar module. This diode may also be permanently connected to the ends of the current collectors 200 (e.g., by welding or soldering).

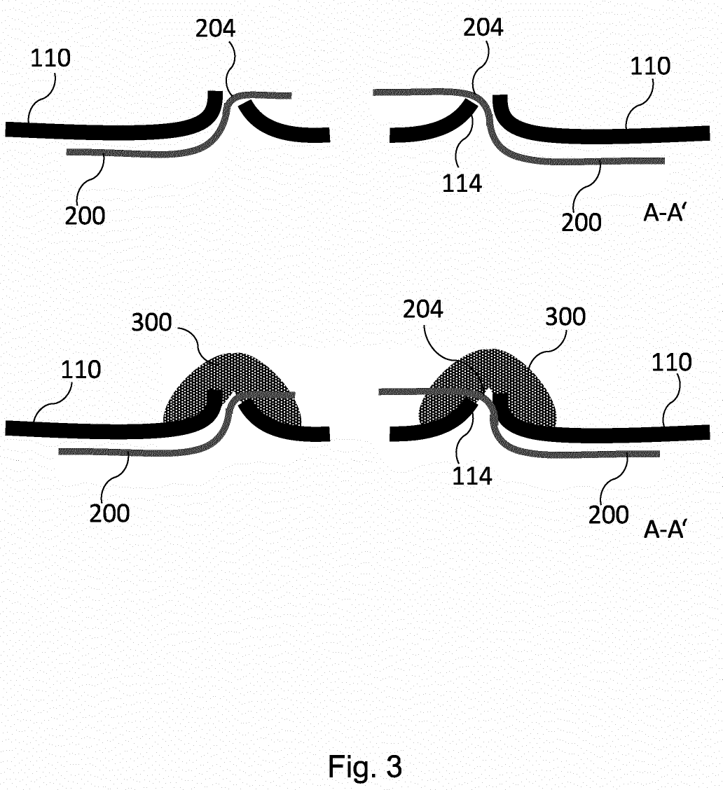

FIG. 3 shows another embodiment for the contact in which the current collectors 200 comprise a bend 204 in the region of the opening 112 of the contacting face 110. Shown are again two cross-sectional views along the cross-sectional line A-A′ (see FIG. 1), where the soldered connection 300 is still missing in the upper view but formed in the lower cross-sectional view. The bend 204 can be formed, for example, by bending the current collectors 200 at the burr 114. This prevents, or at least further impedes, the current collectors 200 from sliding out of the opening 112. Advantageously, the width of the opening 112 is again adapted to the width or geometry of the current collector 200, so that an optional hooking of the current collector 200 at the burr 214 is achieved. This provides additional mechanical retention of the connection. It also improves the electrical contact between the current collectors 200 and the contacting face 110. To further increase electrical contact and stability, the burr 214 may pinch the current collector(s) 200. This may be accomplished by compressing the burr 214 prior to forming the soldered connection 300.

Also in this embodiment, the opening 112 advantageously forms a funnel with the burr 214 to facilitate insertion of the current collector 200 into the opening 112. In this way, the contacting face 110 provides a guide surface that reliably feeds the current collector 200 into the opening 112—even if it is not placed precisely.

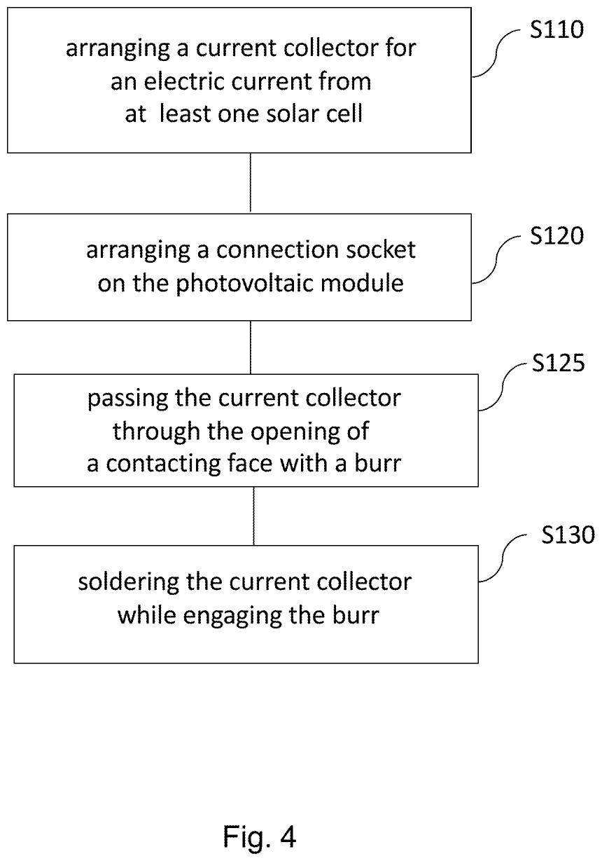

FIG. 4 shows a flowchart for a method of forming a contact for a photovoltaic module. The method includes the steps:
arranging S110 a current collector 200 to conduct away an electric current from at least one solar cell 20 in the photovoltaic module 10;
arranging S120 a connection socket 100 on the photovoltaic module 10, the connection socket 100 comprising a contacting face 110 having an opening 112 and a burr 114 and is configured to be connected to an external supply line 300 for the photovoltaic module 10;
passing S125 the current collector 200 through the opening 112; and
soldering S130 the current collector 200 to the contacting face 110 so that one end of the current collector 200 and the burr 114 are at least partially enclosed by the soldered connection 30.

Other optional process steps include a punching operation to form the openings 112 or a visual inspection of the soldered connection. The punching may be performed such that the punch opening matches (e.g., substantially matches) the cross-section of the current collector 200.

Optionally, a bend or bending over of the current collector 200 may also be performed after the current collector 200 has passed S125 through the opening 112. The bend may be performed at the burr 114 to achieve a hooking of the current collector 110 to the burr 114. At the same time, a portion of the burr 114 may also be bent back to achieve a contact with or a pinching of the current collector(s) 200. For example, the current collector 200 may be in direct contact with the contacting face 110. Optionally, to prevent damage to the current collector 200, a space may also be left between the current collector 200 and the contacting face 110. This space may then be filled with solder material when forming the soldered connection 300.

The process management can be summarized as follows:

Instead of feeding the current collectors 200 into the connection socket and bending them down, this additional process step can be avoided. The current collectors 200 can be made shorter from the laminate in the first place and inserted vertically into the connection socket 100; and without any additional bend. This saves both a process step and material. Then, using non-contact soldering and external tin feed, solder can be applied directly to the current collector 200 from above, which wets and solder both the current collector 200 and the surrounding pre-tinned contacting faces 110. Due to the wetting behavior of the solder, a tin meniscus forms above the current collector 200 in contact with the contacting face 110, thus forming a solid soldered connection between current collectors 200 and the contacting face(s) 110 that can be visually inspected and evaluated from above. With an adapted geometry, the current collector 200 can be more easily fed into and fixed in place in the connection socket 300, while improving solder wettability and formation of the meniscus for evaluation of the soldered connection.

The features of the invention disclosed in the description, the claims and the figures may be essential to the realization of the invention either individually or in any combination.

### LIST OF REFERENCE SIGNS

100, 400 connection socket (junction box)
110, 410 at least one contacting face
112, 412 at least one opening
114 burr at the opening
200, 420 at least one current collector
204 bend
300, 430 soldered connection
d width of the opening

1. A contact for a photovoltaic module, including:
a connection socket attached to the photovoltaic module and comprising a contacting face, the contacting face comprising an opening with a burr and configured to be connected to an external supply line for the photovoltaic module;
a current collector that conducts an electric current from at least one solar cell in the photovoltaic module to the connection socket; and
a soldered connection between the current collector and the contacting face,
wherein the current collector extends through the opening, and the burr points away from the at least one solar cell and is accommodated at least in part by the soldered connection.

2. The contact according to claim 1, wherein the current collector extends at one end nearly perpendicularly away from the solar cells and is at least partially enclosed by the soldered connection.

3. The contact according to claim 1,
wherein a further current collector is included for conducting electric current from the solar cells, and the connection socket comprises a further contacting face and a further opening,
wherein the further current collector extends through the further opening and contacts the further contacting face,
and wherein the contacting face and the further contacting face are electrically connected via a bypass element.

4. The contact according to claim 1, wherein the burr is a punch burr, and the opening is a punched opening.

5. The contact according to claim 4, wherein the opening comprises a width selected such that the current collector is at least partially mechanically retained by canting at the burr.

6. The contact according to claim 1, wherein the current collector comprises a bend at the burr, wherein the bend forms a hook that at least makes it difficult to back out the current collector from the opening.

7. A photovoltaic module with a contact comprising:
a connection socket attached to the photovoltaic module and comprising a contacting face, the contacting face comprising an opening with a burr and configured to be connected to an external supply line for the photovoltaic module;
a current collector that conducts an electric current from at least one solar cell in the photovoltaic module to the connection socket; and
a soldered connection between the current collector and the contacting face,
wherein the current collector extends through the opening, and the burr points away from the at least one solar cell and is accommodated at least in part by the soldered connection.

8. A method of forming a contact for a photovoltaic module, comprising the following steps:
arranging a current collector to conduct away an electric current from at least one solar cell in the photovoltaic module;
arranging of a connection socket on the photovoltaic module, the connection socket comprising a contacting face having an opening and a burr and being configured to be connected to an external supply line for the photovoltaic module;
passing the current collector through the opening; and
soldering the current collector to the contacting face such that one end of the current collector and the burr are at least partially enclosed by the soldered connection.

9. The method of claim 8, further comprising:
bending down the current collector after passing the current collector through the opening, wherein the bending down occurs at the burr to achieve hooking of the current collector to the burr.

10. The method of claim 8, further comprising:
bending the burr after the current collector is inserted into the opening to reduce a width of the opening.
